(19) United States
(12) Patent Application Publication
(10) Pub. No.: US 2009/0295688 A1
(43) Pub. Date: Dec. 3, 2009

(54) PLASMA DISPLAY APPARATUS AND METHOD OF DRIVING THE SAME

(76) Inventors: Byungsoo Song, Seoul (KR); Daejin Myoung, Seoul (KR); Namjin Kim, Seoul (KR); Seonghak Moon, Seoul (KR); Iwamoto ., Seoul (KR)

Correspondence Address: KED & ASSOCIATES, LLP, P.O. Box 221200, Chantilly, VA, 20153-1200, US

(21) Appl. No.: 12/167,315

(22) Filed: Jul. 3, 2008

(30) Foreign Application Priority Data
Jun. 2, 2008 (KR) 10-2008-0051639

(51) Int. Cl. G09G 3/28

(52) U.S. Cl. 345/63

(57) ABSTRACT

A plasma display apparatus and a method of driving the same are disclosed. The method includes assigning a predetermined number of sustain signals to each of subfields constituting a frame depending on weight values of the subfields, selecting some of combinations of the subfields, actually measuring a luminance of light emitted by the plasma display apparatus during a frame comprised of the selected subfield combination, normalizing a luminance corresponding to each subfield combination depending on the actually measured highest luminance to calculate a reference normalized gray level, and calculating an intermediate gray level between the reference normalized gray levels.

This application claims the benefit of Korean Patent Application No. filed on 10-2008-0051639, which is hereby incorporated by reference.

### BACKGROUND

1. Field

An exemplary embodiment relates to a plasma display apparatus and a method of driving the same.

2. Description of the Related Art

A plasma display apparatus generally includes a plasma display panel displaying an image and a driver supplying a drive signal to the plasma display panel.

The plasma display panel includes discharge spaces surrounded by barrier ribs, and each discharge space is filled with a discharge gas. When the driver supplies a drive signal to the discharge space, a discharge occurs inside the discharge space. Hence, the plasma display panel displays an image.

The driver supplies drive signals to the plasma display panel during a reset period, an address period, and a sustain period. The driver supplies a reset signal for initializing a state of wall charges distributed inside the discharge space to the plasma display panel during the reset period, and supplies a scan signal and a data signal for selecting the discharge spaces to emit light to the plasma display panel during the address period. Then, the driver supplies a sustain signal for emitting light from the selected discharge spaces to the plasma display panel during the sustain period. The supply of the sustain signal allows light to be emitted from the discharge spaces selected during the address period, thereby displaying the image on the plasma display panel.

A video signal input from the outside has to be converted through the image processing so as to be suitable for the data signal supplied by the driver during the address period.

### SUMMARY

In one aspect, a method of driving a plasma display apparatus displaying an image comprises assigning a predetermined number of sustain signals to each of subfields constituting a frame depending on weight values of the subfields, selecting some of combinations of the subfields, actually measuring a luminance of light emitted by the plasma display apparatus during a frame comprised of the selected subfield combination, normalizing a luminance corresponding to each subfield combination depending on the actually measured highest luminance to calculate a reference normalized gray level, and calculating an intermediate gray level between the reference normalized gray levels.

The method may further comprise performing a halftoning process on the intermediate gray level to output a final gray level, wherein the final gray level is equal to a subfield mapping code.

The number of final gray levels may be equal to the number of gray levels representable by the plasma display apparatus.

After luminances of light emitted by the plasma display apparatus are actually measured during the plurality of frames comprised of the subfield combination, a sum of the actually measured luminances may be divided by the number of frames.

A luminance of light emitted by the plasma display apparatus may be actually measured during the frame comprised of the subfield combination at a predetermined average picture level (APL).

The reference normalized gray level may be calculated using the following equation: NGL(x)=(Lum x/Lum m)×the maximum number of representable gray levels, where NGL(x) is a reference normalized gray level depending on x-th subfield combination, Lum m is a highest luminance, and Lum x is a luminance depending on the x-th subfield combination.

An actual gray level may be calculated using the following equation: GR=NGL(x)+(GREYRE−NGL(x))/(NGL(x+1)−NGL(x)), where GR is the actual gray level, NGL(x) is a reference normalized gray level depending on x-th subfield combination, NGL(x+1) is a reference normalized gray level depending on (x+1)-th subfield combination, and GREYRE is a gray level of a video signal.

In another aspect, a plasma display apparatus displaying an image during a frame comprised of subfields comprises a first calculation unit that compares a gray level of an inverse-gamma corrected video signal with a reference normalized gray level to calculate an integer gray level of the video signal, a second calculation unit that compares the gray level of the inverse-gamma corrected video signal with the reference normalized gray level to calculate a decimal gray level corresponding to the gray level of the inverse-gamma corrected video signal, and a halftoning unit that receives the integer gray level and the decimal gray level from the first calculation unit and the second calculation unit to calculate an actual gray level and performs a halftoning process on the decimal gray level to output a final gray level, wherein the reference normalized gray level is calculated by selecting some of combinations of the subfields, actually measuring a luminance of light emitted by the plasma display apparatus during a frame comprised of the selected subfield combination, and normalizing a luminance corresponding to each subfield combination depending on the actually measured highest luminance to calculate a reference normalized gray level.

The plasma display apparatus may further comprise a memory unit storing the reference normalized gray level or a gray level calculation unit providing the reference normalized gray level.

The final gray level may be equal to a subfield mapping code.

The number of final gray levels may be equal to the number of gray levels representable by the plasma display apparatus.

After luminances of light emitted by the plasma display apparatus are actually measured during the plurality of frames comprised of the subfield combination, the reference normalized gray level may be calculated by dividing a sum of the actually measured luminances by the number of frames and normalizing the luminance corresponding to the subfield combination depending on the actually measured highest luminance.

The reference normalized gray level may be calculated by actually measuring a luminance of light emitted by the plasma display apparatus during a frame comprised of the subfield combination at a predetermined APL and normalizing the luminance corresponding to the subfield combination depending on the actually measured highest luminance.

### BRIEF DESCRIPTION OF THE DRAWINGS

The accompany drawings, which are included to provide a further understanding of the invention and are incorporated on and constitute a part of this specification, illustrate embodiments of the invention and together with the description serve to explain the principles of the invention. In the drawings:

FIG. 1 shows a plasma display apparatus according to an exemplary embodiment;

FIG. 2 shows a drive signal of the plasma display apparatus according to the exemplary embodiment;

FIG. 3 shows a controller of FIG. 1;

FIG. 4 illustrates a method for representing a gray level according to the exemplary embodiment;

FIG. 5 is a table showing a luminance corresponding to each reference subfield code;

FIG. 6 is a table showing a luminance corresponding to each reference subfield code and each APL;

FIG. 7 is a table showing a reference normalized gray level of a luminance corresponding to each reference subfield code at each APL;

FIG. 8 shows another configuration of a controller of FIG. 1;

FIG. 9 is a table showing a luminance corresponding to each actual gray level at a predetermined APL; and

FIG. 10 is a subfield mapping table depending on a final gray level.

### DETAILED DESCRIPTION OF EMBODIMENTS

Reference will now be made in detail embodiments of the invention examples of which are illustrated in the accompanying drawings.

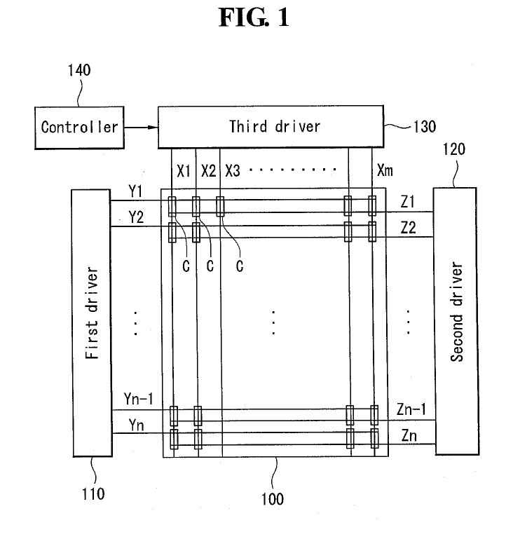

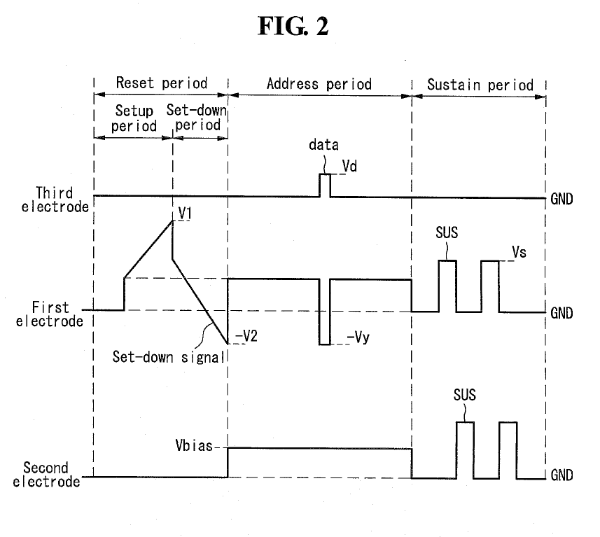

FIG. 1 shows a plasma display apparatus according to an exemplary embodiment, and FIG. 2 shows a drive signal of the plasma display apparatus.

As shown in FIGS. 1 and 2, the plasma display apparatus according to the exemplary embodiment includes a plasma display panel 100, a first driver 110, a second driver 120, a third driver 130, and a controller 140.

The plasma display panel 100 includes an upper panel (not shown) and a lower panel (not shown), which coalesce with each other at a given distance. The upper panel includes first electrodes Y1 to Yn and second electrodes Z1 to Zn positioned parallel to each other, and the lower panel includes third electrodes X1 to Xm intersecting the first electrodes Y1 to Yn and the second electrodes Z1 to Zn. The plasma display panel 100 includes discharge cells C at each of intersections of the first and second electrodes Y1 to Yn and Z1 to Zn and the third electrodes X1 to Xm.

The first driver 110 supplies a setup signal, which gradually rises from a reference voltage to a first voltage V1, to the first electrodes Y1 to Yn during a setup period of a reset period. The reference voltage may be a ground level voltage GND. The supply of the setup signal allows a sufficient amount of wall charges to be accumulated on the first electrodes Y1 to Yn.

After the supply of the setup signal, the first driver 110 supplies a set-down signal, which gradually falls to a second voltage −V2, to the first electrodes Y1 to Yn during a set-down period of the reset period. Hence, some of the wall charges accumulated during the setup period are erased, and a proper amount of wall charges remain on the first electrodes Y1 to Yn to the extent that an address discharge can occur.

During an address period, the first driver 110 supplies a scan signal falling to a scan voltage −Vy to the first electrodes Y1 to Yn, and the third driver 130 supplies a data signal data rising to a data voltage Vd to the third electrodes X1 to Xm. Hence, an address discharge for selecting the discharge cells to emit light occurs.

The second driver 120 supplies a sustain bias voltage Vbias to the second electrodes Z1 to Zn during the address period to thereby smoothly generate the address discharge between the first electrodes Y1 to Yn and the third electrodes X1 to Xm. The sustain bias voltage Vbias may be supplied during the set-down period and the address period.

During a sustain period, the first driver 110 and the second driver 120 supply sustain signals SUS, which allow a voltage difference between the first electrodes Y1 to Yn and the second electrodes Z1 to Zn to be a sustain voltage Vs, so as to emit light from the selected discharge cells.

The controller 140 controls operations of the first, second, and third drivers 110, 120, and 130, and performs the image processing on a video signal input from the outside so as to be suitable for the data signal supplied by the third driver 130.

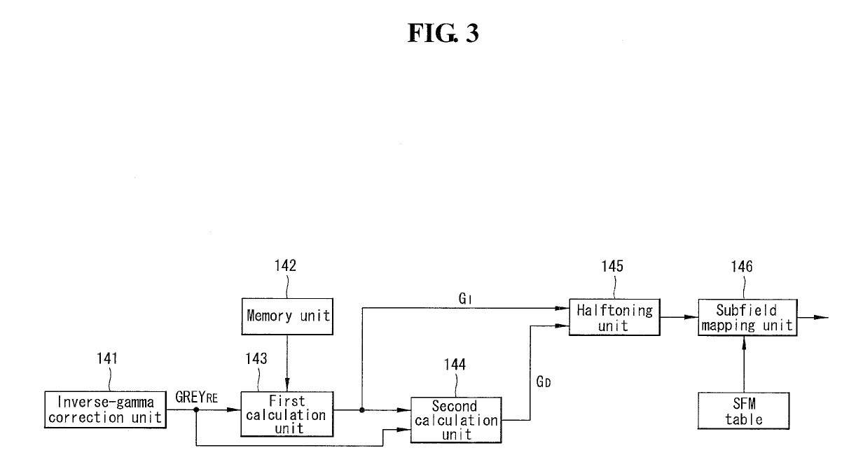

FIG. 3 shows the controller 140 of FIG. 1. As shown in FIG. 3, the controller 140 includes an inverse-gamma correction unit 141, a memory unit 142, a first calculation unit 143, a second calculation unit 144, a halftoning unit 145, and a subfield mapping unit 146.

The inverse-gamma correction unit 141 performs an inverse-gamma correction process on a video signal input from the outside. Although the video signal is inverse-gamma corrected by the inverse-gamma correction unit 141 in the exemplary embodiment, an inverse-gamma corrected video signal may be directly supplied to the first calculation unit 143 and the second calculation unit 144.

The memory unit 142 stores a reference normalized gray level corresponding to each reference subfield code and each average picture level (APL). The reference normalized gray level will be described later with reference to the accompanying drawings.

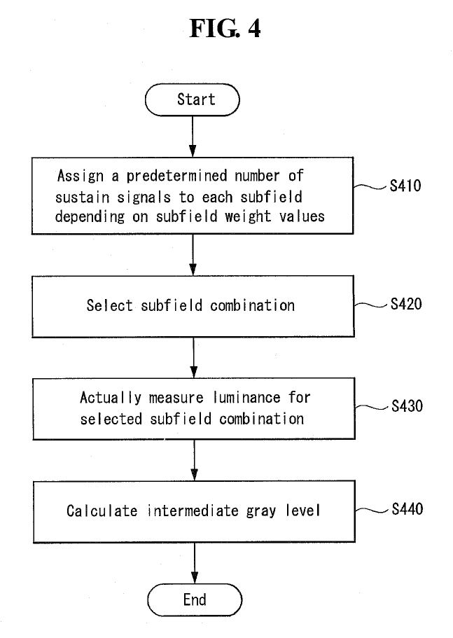

A method for representing a gray level according to the exemplary embodiment will be described below with reference to FIG. 4.

As shown in FIG. 4, a predetermined number of sustain signals are assigned to each of subfields constituting a frame depending on weight values of the subfields in step S410.

For example, in case the total number of sustain signals is 1023, one sustain signal may be assigned to a subfield SF1 and 512 sustain signals may be assigned to a subfield SF10.

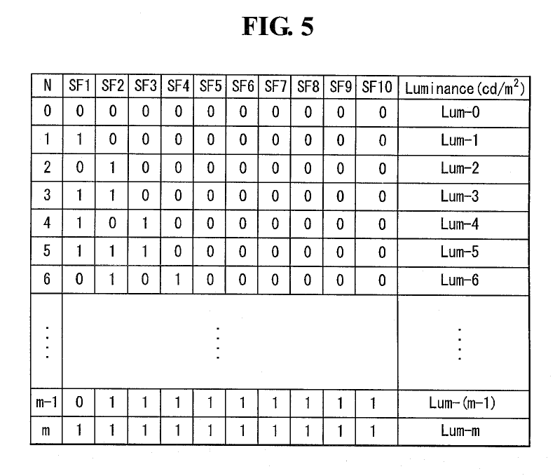

Next, as shown in FIG. 4, some of combinations of the subfields constituting the frame are selected in step S420. In other word, the number of reference subfield codes is smaller than the number of combinations of all the subfields constituting the frame. For example, as shown in FIG. 5, if the total number of subfields constituting a frame is 10, the total number of combinations of the 10 subfields is 1024 and the number of reference subfield codes is smaller than 1024.

If all the subfield combinations are used, a memory capacity for storing reference subfield codes increases and the calculation amount increases. Accordingly, in the exemplary embodiment, the storing capacity of the subfield codes and the calculation amount are reduced by using some of all the subfield combinations. The subfield combinations used may be voluntarily selected.

As described above, in case some subfield combinations are used, the number of subfield combinations removed between the two reference subfield codes may be equal to each other in all the subfields. For example, the number of subfield combinations removed between reference subfield codes 0 and 1 may be equal to the number of subfield combinations removed between reference subfield codes 1 and 2 and the number of subfield combinations removed between reference subfield codes 2 and 3.

In case the number of subfield combinations removed between the two reference subfield codes is equal to each other, it is easy to make the table shown in FIG. 5.

As shown in FIG. 4, a luminance of light emitted by the plasma display apparatus is actually measured during a frame comprised of the selected subfield combination in step S430.

As described above, after the subfield combination is selected, as shown in FIG. 5, a luminance of light emitted by the plasma display apparatus is actually measured during a frame comprised of the selected subfield combination, and then the actually measured luminance matches the reference subfield code of FIG. 5. For example, the subfield combination matching the reference subfield code 1 corresponds to the case where the subfield SF1 is turned on and the other subfields SF2 to SF10 are turned off. The subfield combination matching the reference subfield code m-1 corresponds to the case where the subfield SF1 is turned off and the other subfields SF2 to SF10 are turned on.

Luminances Lum-0, Lum-1, . . . , Lum-(m-1), Lm-m of light emitted by the plasma display apparatus are actually measured during the frame comprised of the selected subfield combinations, and the actually measured luminances match the reference subfield mapping codes, respectively. For example, while the subfield combination matching the reference subfield code 3 (N=3), namely, the subfields SF1 and SF2 are turned on and the subfields SF3 to SF10 are turned off, the luminance of light emitted by the plasma display apparatus may be actually measured by a luminance measuring device (not shown).

The luminances may be actually measured during a plurality of frames comprised of the subfield combination corresponding to the reference subfield code. For instance, after luminances are actually measured during n frames comprised of the subfield combination corresponding to reference subfield code 3 (N=3), a sum of the actually measured luminances is divided by the number of frames (=n) to calculate a luminance of light emitted during one frame.

At this time, each of luminances actually measured during one or more frames includes the luminance measured during reset and address periods as well as the luminance measured during a sustain period.

Because the luminances of light emitted by the plasma display apparatus are actually measured during one or more frames, the luminances corresponding to reference subfield codes may be different from one another depending on characteristics of the plasma display panel and characteristics of the driver. In other words, the luminances actually measured during one or more frames corresponding to the equal reference subfield code may be different from one another depending on the characteristics of the plasma display panel and the characteristics of the driver. Accordingly, because the luminance corresponding to each reference subfield code is actually measured in the exemplary embodiment, a gray level can be finely represented depending on the characteristics of the plasma display panel and the characteristics of the driver.

The actual measurement of luminances of the plasma display panel depending on the reference subfield code can represent more finely the gray level as compared with the calculation of luminances using modeling for the above-described reason. In other words, in the modeling for calculating the luminance of the plasma display panel, a luminance in relation to the supply of one reset signal, a luminance in relation to the supply of a scan signal and an address signal, and a luminance in relation to the supply of one sustain signal are applied without considering the characteristics of the plasma display panel and the characteristics of the driver.

For example, in case a standardized luminance of each driving signal is applied so as to calculate a luminance corresponding to an equal subfield combination, it may be calculated that an equal luminance is emitted in plasma display panels having different characteristics.

For example, in the luminance calculation through the modeling, when a sustain signal, whose a luminance is previously calculated, is supplied n times, it is calculated that a luminance of the panel increases n times. However, the amount of light capable of being emitted by the phosphor of the plasma display panel does not linearly increase, and also the amount of light is saturated when a specific number of sustain signals is supplied. Accordingly, the actual measurement of the luminance of the plasma display panel as in the exemplary embodiment allows the gray level to be represented more precisely.

In case the luminance of the plasma display panel is actually measured depending on the subfield combination corresponding to the reference subfield code as in the exemplary embodiment, the luminance can be precisely calculated depending on the characteristics of the plasma display panel or the driver.

In the exemplary embodiment, after the subfield combination is selected, the luminance corresponding to the selected subfield combination is actually measured. The actually measured luminances may be indicated by the table of FIG. 5. In other words, the exemplary embodiment is more efficient than a method in which after all of subfield combinations of subfields constituting one frame are made, a luminance corresponding to each of all the subfield combinations is actually measured.

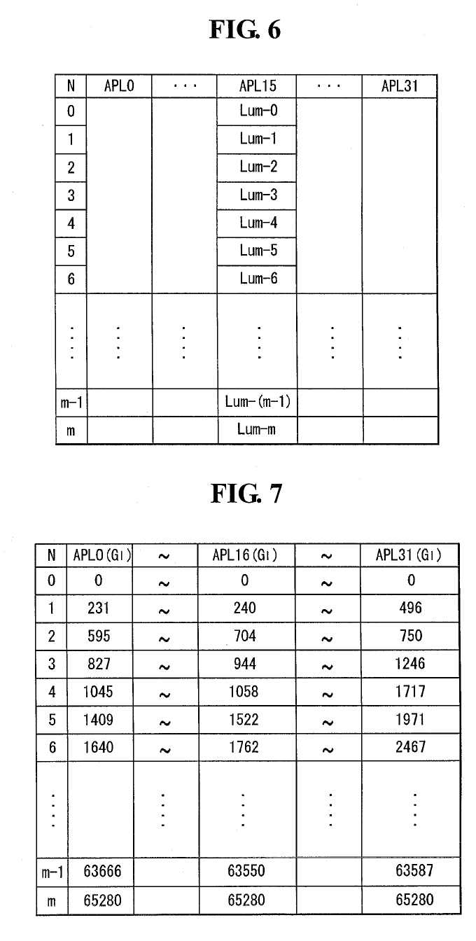

As shown in FIG. 6, a luminance corresponding to each reference subfield code and each APL can be actually measured. In other words, because the number of sustain signals assigned to a frame depends on an APL of the frame, a different number of sustain signals may be assigned to each of subfields constituting the frame. If the sustain signals is assigned to the subfields depending on each subfield combination matching each reference subfield code at a predetermined APL, the luminances Lum-0, Lum-1, . . . , Lum-(m-1), Lum-m of light emitted by the plasma display apparatus are actually measured at the predetermined APL during one frame. As described above, because the luminance is actually measured at each APL, a gray level can be finely represented during an operation of the plasma display apparatus.

Next, as shown in FIG. 4, a luminance corresponding to each subfield combination is normalized depending on the measured highest luminance to calculate a reference normalized gray level in step S430. As shown in FIG. 6, a normalization of the luminance corresponding to each reference subfield code at the predetermined APL can be achieved by the following Equation 1.

NGL(x)=(Lum x/Lum m)×the maximum number of representable gray levels [Equation 1]

In the above Equation 1, NGL(x) is a reference normalized gray level in a reference subfield code of x at a predetermined APL, Lum m is a highest luminance at the predetermined APL, and Lum x is a luminance in the reference subfield code of x at the predetermined APL.

The maximum number of gray levels representable by the plasma display panel 100 may depend on bits for input gray level information. For example, in case input gray level information is 16-bit, the maximum number of representable gray levels is 216. Further, because all the subfields are turned on in the reference subfield code of m, a highest luminance is obtained in the reference subfield code of m.

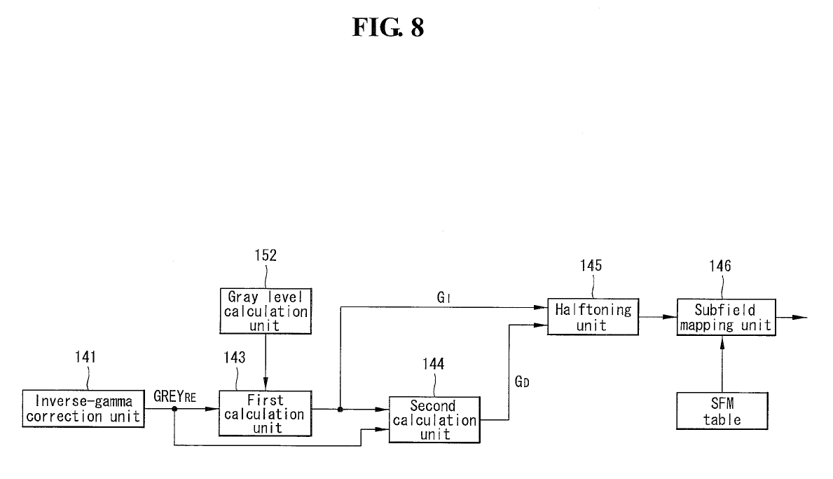

FIG. 7 shows the reference normalized gray level calculated through the above Equation 1. Because the reference normalized gray level depends on the maximum number of representable gray levels, bits in the maximum number of representable gray levels is equal to bits in the reference normalized gray level. The reference normalized gray level shown in FIG. 7 may be stored in the memory unit 142 as shown in FIG. 3, and may be provided by a gray level calculation unit 153 as shown in FIG. 8.

After the reference normalized gray levels are calculated, as shown in FIG. 4, an intermediate gray level between the reference normalized gray levels is calculated in step S440.

The first calculation unit 143 compares a gray level of the inverse-gamma corrected video signal input from the inverse-gamma correction unit 141 with the reference normalized gray level stored in the memory unit 142 or provided by the gray level calculation unit 153 to calculate an integer gray level G_{I} of the video signal having a value larger than 0. The first calculation unit 143 calculates the integer gray level GI using the following Equation 2.

NGL(x)≦GREY_{RE}<NGL(x+1) [Equation 2]

In the above Equation 2, GREY_{RE} is a gray level of the inverse-gamma corrected video signal input from the inverse-gamma correction unit 141, NGL(x) is a reference normalized gray level equal to or smaller than the gray level GREY_{RE}, and NGL(x+1) is a reference normalized gray level larger than the gray level GREY_{RE}.

More specifically, the first calculation unit 143 receives the gray level GREY_{RE} of the inverse-gamma corrected video signal from the inverse-gamma correction unit 141, compares the reference normalized gray levels of FIG. 7 with the gray level GREY_{RE}, and selects the reference normalized gray level NGL(x) equal to or smaller than the gray level GREY_{RE} and the reference normalized gray level NGL(x+1) larger than the gray level GREY_{RE}. Then, the first calculation unit 143 sets the reference normalized gray level NGL(x) as the integer gray level GI.

For instance, supposing that a gray level GREY_{RE} of 16-bit video signal input from the inverse-gamma correction unit 141 at APL of 0 is 700, the gray level GREY_{RE} (=700) of 16-bit video signal is larger than the reference normalized gray level NGL(2)(=595) and smaller than the reference normalized gray level NGL(3)(=827). Therefore, the integer gray level G_{I} of the 16-bit video signal is the reference normalized gray level NGL(2)(=595).

The second calculation unit 144 compares the gray level GREY_{RE} of video signal input from the inverse-gamma correction unit 141 with the reference normalized gray level to calculate a decimal gray level G_{D} of the video signal. The second calculation unit 144 calculates the decimal gray level G_{D} using the following Equation 3.

G_{D}=(GREY_{RE}−NGL(x))/(NGL(x+1)−NGL(x)) [Equation 3]

In the above Equation 3, GREY_{RE} is a gray level of the inverse-gamma corrected video signal input from the inverse-gamma correction unit 141, NGL(x) is a reference normalized gray level equal to or smaller than the gray level GREY_{RE}, and NGL(x+1) is a reference normalized gray level larger than the gray level GREY_{RE}.

More specifically, the second calculation unit 144 receives the gray level GREY_{RE} of the video signal from the inverse-gamma correction unit 141, compares the reference normalized gray levels of FIG. 7 with the gray level GREY_{RE} of the video signal, and selects the reference normalized gray level NGL(x) equal to or smaller than the gray level GREY_{RE} and the reference normalized gray level NGL(x+1) larger than the gray level GREY_{RE}. Then, the second calculation unit 144 calculates the decimal gray level G_{D} using the above Equation 3.

For instance, supposing that a gray level GREY_{RE} of a video signal input from the inverse-gamma correction unit 141 at APL of 0 is 700, the gray level GREY_{RE} (=700) of the video signal is larger than the reference normalized gray level NGL(2)(=595) and smaller than the reference normalized gray level NGL(3)(=827). The second calculation unit 144 calculates the decimal gray level G_{D} using the reference normalized gray levels NGL(2)(=595) and NGL(3)(=827) and the above Equation 3.

The halftoning unit 145 receives the integer gray level G_{I} and the decimal gray level G_{D} from the first and second calculation units 143 and 144 to calculate an actual gray level G_{R} at the predetermined APL. Then, the halftoning unit 145 performs a halftoning process on the decimal gray level GD. In other words, the halftoning unit 145 calculates the actual gray level G_{R} at the predetermined APL using the following Equation 4.

G_{R}=G_{I}+G_{D}=NGL(x)+(GREY_{RE}−NGL(x))/(NGL(x+1)−NGL(x)) [Equation 4]

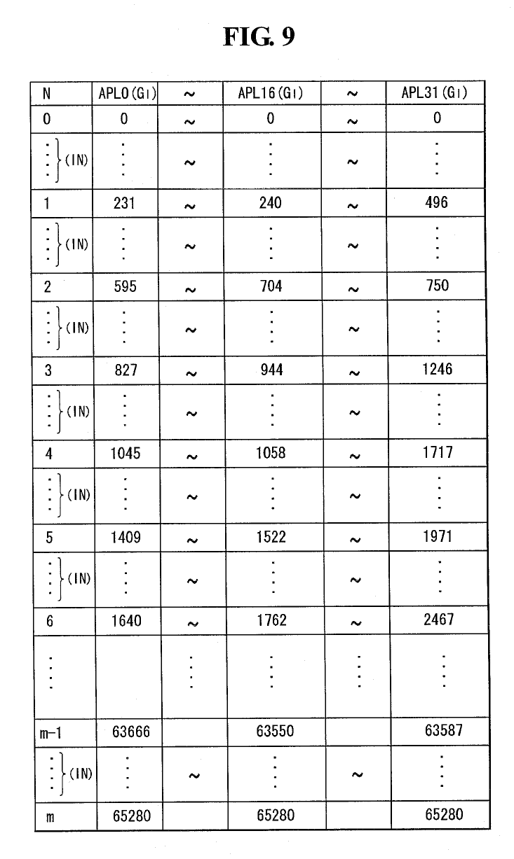

In case the decimal gray level G_{D} is not 0, the actual gray level G_{R} is a value between two adjacent integer gray levels GI. As shown in FIG. 9, an intermediate subfield code IN is positioned between the reference subfield codes of the two adjacent integer gray levels NGL(x) and NGL(x+1). Accordingly, in case the decimal gray level G_{D} is not 0, the actual gray level G_{R} is an intermediate gray level between the reference normalized gray levels.

In case the actual gray level G_{R} corresponds to the intermediate subfield code IN, the halftoning unit 145 performs at least one of a dithering process or an error diffusion process on the decimal gray level G_{D} input from the second calculation unit 144 because the intermediate subfield code IN includes the decimal gray level GD. Then, the halftoning unit 145 converts the actual gray level G_{R} into a final gray level GF to output the final gray level GF. The number of final gray levels GF is equal to the number of gray levels representable by the plasma display panel 100. For instance, if the plasma display panel 100 displays an image using 256 gray levels, the number of final gray levels GF is 256.

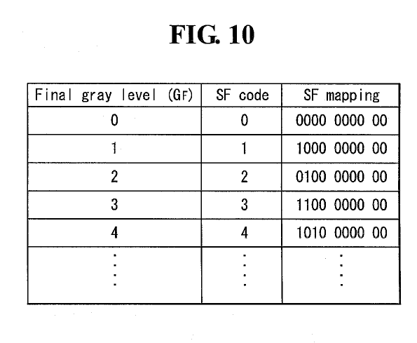

The subfield mapping unit 146 performs a subfield mapping process depending on the final gray level GF. The subfield mapping unit 146 maps the subfields using a subfield mapping table shown in FIG. 10. As described above, because the number of final gray levels SF is equal to the number of gray levels representable by the plasma display panel 100, as shown in FIG. 10, the final gray level GF may be equal to a subfield mapping code. Accordingly, the final gray level GF can be directly mapped to the corresponding subfield mapping code without a separate calculation. The subfield mapping code is a code corresponding to the combination of subfields for achieving the gray levels representable by the plasma display panel 100.

After the subfield mapping process is completed, a final video signal is supplied to the third driver 130 during the mapped subfields. Then, the third driver 130 supplies a data signal corresponding to the final video signal to the third electrodes X1 to Xm of the plasma display panel 100. Hence, the discharge cells to emit light are selected.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A method of driving a plasma display apparatus displaying an image comprising:
assigning a predetermined number of sustain signals to each of subfields constituting a frame depending on weight values of the subfields;
selecting some of combinations of the subfields;
actually measuring a luminance of light emitted by the plasma display apparatus during a frame comprised of the selected subfield combination;
normalizing a luminance corresponding to each subfield combination depending on the actually measured highest luminance to calculate a reference normalized gray level; and
calculating an intermediate gray level between the reference normalized gray levels.

2. The method of claim 1, further comprising performing a halftoning process on the intermediate gray level to output a final gray level,
wherein the final gray level is equal to a subfield mapping code.

3. The method of claim 2, wherein the number of final gray levels is equal to the number of gray levels representable by the plasma display apparatus.

4. The method of claim 1, wherein after luminances of light emitted by the plasma display apparatus are actually measured during the plurality of frames comprised of the subfield combination, a sum of the measured luminances is divided by the number of frames.

5. The method of claim 1, wherein a luminance of light emitted by the plasma display apparatus is actually measured during the frame comprised of the subfield combination at a predetermined average picture level (APL).

6. The method of claim 1, wherein the reference normalized gray level is calculated using the following equation: NGL(x)=(Lum x/Lum m)×the maximum number of representable gray levels, where NGL(x) is a reference normalized gray level depending on x-th subfield combination, Lum m is a highest luminance, and Lum x is a luminance depending on the x-th subfield combination.

7. The method of claim 1, wherein an actual gray level is calculated using the following equation: G_{R}=NGL(x)+(GREY_{RE}−NGL(x))/(NGL(x+1)−NGL(x)), where G_{R} is the actual gray level, NGL (x) is a reference normalized gray level depending on x-th subfield combination, NGL(x+1) is a reference normalized gray level depending on (x+1)-th subfield combination, and GREY_{RE} is a gray level of a video signal.

8. A plasma display apparatus displaying an image during a frame comprised of subfields comprising:
a first calculation unit that compares a gray level of an inverse-gamma corrected video signal with a reference normalized gray level to calculate an integer gray level of the video signal;
a second calculation unit that compares the gray level of the inverse-gamma corrected video signal with the reference normalized gray level to calculate a decimal gray level corresponding to the gray level of the inverse-gamma corrected video signal; and
a halftoning unit that receives the integer gray level and the decimal gray level from the first calculation unit and the second calculation unit to calculate an actual gray level and performs a halftoning process on the decimal gray level to output a final gray level,
wherein the reference normalized gray level is calculated by selecting some of combinations of the subfields, actually measuring a luminance of light emitted by the plasma display apparatus during a frame comprised of the selected subfield combination, and normalizing a luminance corresponding to each subfield combination depending on the actually measured highest luminance to calculate a reference normalized gray level.

9. The plasma display apparatus of claim 8, further comprising a memory unit storing the reference normalized gray level or a gray level calculation unit providing the reference normalized gray level.

10. The plasma display apparatus of claim 8, wherein the final gray level is equal to a subfield mapping code.

11. The plasma display apparatus of claim 10, wherein the number of final gray levels is equal to the number of gray levels representable by the plasma display apparatus.

12. The plasma display apparatus of claim 8, wherein after luminances of light emitted by the plasma display apparatus are measured during a plurality of frames comprised of the subfield combination, the reference normalized gray level is calculated by dividing a sum of the measured luminances by the number of frames and normalizing the luminance corresponding to the subfield combination depending on the measured highest luminance.

13. The plasma display apparatus of claim 8, wherein the reference normalized gray level is calculated by measuring a luminance of light emitted by the plasma display apparatus during a frame comprised of the subfield combination at a predetermined APL and normalizing the luminance corresponding to the subfield combination depending on the measured highest luminance.
